(19) United States
(12) Patent Application Publication
(10) Pub. No.: US 2014/0331295 A1
(43) Pub. Date: Nov. 6, 2014

(54) CREDENTIAL MANAGEMENT GATEWAY AND METHOD

(71) Applicant: Rogers Communications Inc., Toronto (CA)

(72) Inventors: Vinay KUMAR, Brampton (CA); Jeppe DORFF RAMLAU-HANSEN, Toronto (CA)

(21) Appl. No.: 13/875,344

(22) Filed: May 2, 2013

(51) Int. Cl. H04L 29/06

(52) U.S. Cl. CPC H04L 63/08
USPC 726/6

(57) ABSTRACT

Methods and devices for providing credentials to third parties are described. In one aspect, a method provided by a credential management gateway is described. The credential management gateway is coupled with a wireless network servicing a plurality of mobile communication devices. The method includes: receiving, from a credential requesting device, a personal credential information query, the query indicating unique identification information and type information indicating particulars of the query; and in response to receiving the personal credential information query: i) sending, to a credential management application of the mobile communication device that is associated with the unique identification information, a personal credential information request, the credential management application being configured to respond to the personal credential information request based on personal credential information stored in a secure area of a memory module associated with the mobile communication device and based on release authorization instructions; ii) receiving, from the mobile communication device, a response to the request; and iii) sending a response to the personal credential information query to the credential requesting device based on the response received from the mobile communication device, the response sent to the credential requesting device indicating whether a user associated with the mobile communication device is associated with a credential specified by the type information.

### TECHNICAL FIELD

The present disclosure relates generally to authentication systems and, more particularly, to systems for providing credentials to third parties.

### BACKGROUND

Identity documents have traditionally been used for the purpose of verifying aspects of a person's personal identity. Such documents are often issued in the form of a card, in which case they may be referred to as an identity card. Identity documents may, for example, include a driver's license, a passport, a birth certificate, a membership card, etc.

Such documents are sometimes used to verify a credential associated with a person. The credential may, for example, be a birthdate, a country of citizenship, a professional membership, or a credential of another type. More particularly, a person may carry a collection of such documents which may be used to prove to a third party that the user has a particular credential. Such cards often include an identifier, such as a number, which is unique to the person. For example, a driver's license may have a driver's license number printed thereon, a passport may have a passport number, etc.

By way of further example, a professional may carry a card that indicates that the person is a member of a particular professional body, such as an identity card which indicates that the person is a professional. The card may have an identification number printed thereon which the person may use to identify themselves in dealings with the professional body. This number may, therefore, be used to verify that the person is associated with the professional organization.

Thus, the use of physical cards having unique numbers has traditionally been used to allow a credential associated with a user to be verified. This method may require a user to carry a great number of cards. Also, fraudulent cards may be prepared to allow a user to appear to have a credential which they do not, in fact, possess. For example, a fake driver's license may be prepared to indicate a birth date that is not the birth date of the user or to indicate that the user has a driver's license when they do not, in fact, have a driver's license.

### BRIEF DESCRIPTION OF THE DRAWINGS

Reference will now be made, by way of example, to the accompanying drawings which show an embodiment of the present application, and in which:

FIG. 1 shows a block diagram illustrating an example mobile communication device in which example embodiments of the present disclosure may operate;

FIG. 2 shows a block diagram of an example credential providing system in accordance with example embodiment of the present disclosure;

FIG. 3 shows a block diagram of an example credential management gateway in accordance with example embodiments of the present disclosure;

FIG. 4 shows a flowchart of an example method of loading personal credential information onto a mobile communication device in accordance with example embodiments of the present disclosure; and

FIG. 5 shows a flowchart of an example method of providing information about credentials to a credential requesting device in accordance with example embodiments of the present disclosure.

Similar reference numerals are used in different figures to denote similar components.

### DETAILED DESCRIPTION OF EXAMPLE EMBODIMENTS

In one aspect, a method provided by a credential management gateway is described. The credential management gateway is coupled with a wireless network servicing a plurality of mobile communication devices. The method includes: receiving, from a credential requesting device, a personal credential information query, the query indicating unique identification information and type information indicating particulars of the query; and in response to receiving the personal credential information query: i) sending, to a credential management application of the mobile communication device that is associated with the unique identification information, a personal credential information request, the credential management application being configured to respond to the personal credential information request based on personal credential information stored in a secure area of a memory module associated with the mobile communication device and based on release authorization instructions; ii) receiving, from the mobile communication device, a response to the request; and iii) sending a response to the personal credential information query to the credential requesting device based on the response received from the mobile communication device, the response sent to the credential requesting device indicating whether a user associated with the mobile communication device is associated with a credential specified by the type information.

In another aspect, a credential management gateway is described. The credential management gateway includes a first communication interface for communicating with a credential requesting device and a second communication interface for communicating with a mobile communication device. The credential management gateway further includes a processor coupled with the first communication interface and the second communication interface. The processor is configured to: receive, from a credential requesting device, a personal credential information query, the query indicating unique identification information and type information indicating particulars of the query; and in response to receiving the personal credential information query: i) send, to a credential management application of the mobile communication device that is associated with the unique identification information, a personal credential information request, the credential management application being configured to respond to the personal credential information request based on personal credential information stored in a secure area of a memory module associated with the mobile communication device and based on release authorization instructions; ii) receive, from the mobile communication device, a response to the request; and iii) send a response to the personal credential information query to the credential requesting device based on the response received from the mobile communication device, the response sent to the credential requesting device indicating whether a user associated with the mobile communication device is associated with a credential specified by the type information.

In yet another aspect, a method provided by a mobile communication device. The method includes: receiving personal credential information from a credential issuing authority via a communication subsystem of the mobile communication device; storing the personal credential information on a secure area of the memory module; receiving a personal credential information request from a credential management gateway, the credential management gateway being configured to receive a personal information query from a credential requesting device and, in response to receiving the query, to send the personal credential information request, the request specifying type information indicating a credential associated with the request; and when release authorization instructions received via an input interface of the mobile communication device authorize the mobile communication device to comply with the personal credential information request, sending a response to the request based on the personal credential information.

Other aspects and features of the present application will become apparent to those ordinarily skilled in the art upon review of the following description of specific embodiments of the application in conjunction with the accompanying figures.

### Example Mobile Communication Device

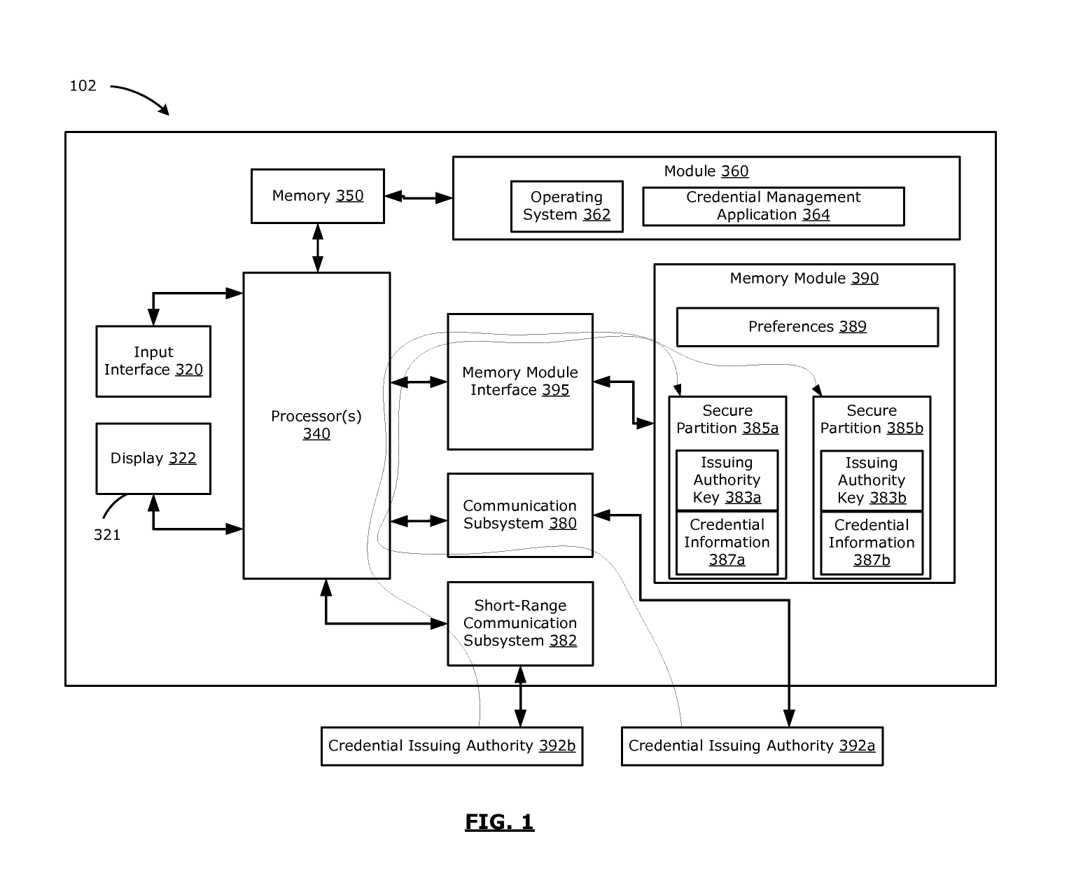

Reference is first made to FIG. 1 which illustrates an example mobile communication device 102 in block diagram form. In the illustrated example embodiments, the mobile communication device 102 is a smartphone which is capable of voice and data communications with other devices, systems and servers, for example, via a wireless network.

The mobile communication device 102 includes a controller which may include one or more processors 340 that control the overall operation of the mobile communication device 102. The processor 340 may be communicably coupled with device subsystems including one or more input interfaces 320 (such as a keyboard, control buttons, a microphone, a touchscreen display, a mouse, a trackpad, a microphone and/or other input interfaces), one or more output interfaces 321 (such as a display 322 and/or a speaker), memory 350 (which may include multiple memory components of various types such as flash memory, random access memory (RAM), read only memory (ROM), a hard disk drive (HDD), a solid state drive (SSD), or other types of memory), a communication subsystem 380 for communicating either wirelessly or non-wirelessly with other systems, servers and/or electronic devices, and a short-range communication subsystem 382 (to allow for short-range communication such as near field communication (NFC) or Bluetooth). The processor 340 may be communicably coupled with other device subsystems not specifically described herein.

In at least some example embodiments, the mobile communication device 102 may also include one or more removable memory modules 390 and a memory module interface 395. The mobile communication device 102 may access the wireless networks via the memory module 390, which may include one or more physical universal integrated circuit cards (UICC), which may also be referred to as a subscriber identity module (SIM) card. The memory module 390 may be inserted in or connected to the memory module interface 395 of the mobile communication device 102.

A SIM card is an integrated circuit that includes a processor and memory, and may store unique identifiers identifying the end-user of the mobile communication device 102, security keys, a subscription service package provided by the wireless service provider that define the communication services of the mobile communication device 102 including roaming policy rates of usage, subscription preferences, wireless network information, etc. In at least some example embodiments, the SIM card may further store financial institution and financial instrument information (i.e. the SIM card may allow the electronic device to function as a “mobile wallet”). This financial information may be sent from the mobile communication device 102 to a POS terminal via the short-range communication subsystem 382 during a mobile payment transaction. The SIM cards are provided by wireless network service providers to manage wireless network communication services for the mobile communication device 102. In some cases, the mobile communication device 102 may include an embedded SIM card that is not removable.

To provide further “mobile wallet” functionality, the memory module 390 may store identification information associated with a user of the mobile communication device 102. More particularly, in at least some embodiments, the memory module 390 (which may be a SIM card) may store personal credential information 387a, 387b. The personal credential information specifies one or more personal credentials associated with a user of the mobile communication device 102. Such personal credential information may, in at least some embodiments, be information of the type that is traditionally found on an identification card. For example, such personal credential information may include information of the type typically found on a driver's license, a passport, an employee identification card, a visa or other immigration document, a membership card such as a membership card to a professional licensing body or a group or club of another type, etc. Thus, the personal credential information indicates certain credentials that are associated with the user of the mobile communication device 102. For example, the personal credential information 387a, 387b may specify that the user possesses particular credentials such as a valid driver's license, a passport, a particular immigration or citizenship status for an associated country, an employment status (e.g., a credential may indicate that the user is employed, employed full time, employed part time and/or not employed), a professional designation (e.g. it may specify whether the user is a doctor, lawyer, engineer, etc.), an education status (e.g. it may specify whether the user is a college or university graduate (and may particularize the type of degree or diploma possessed by the user), a membership to a group (e.g. it may specify whether the user is a member of a particular group such as a fan club). Other types of credentials may be specified by the personal credential information in other embodiments.

Personal credential information 387a, 387b may be stored in one or more secure areas of the memory module 390. More particularly, in at least some embodiments, the personal credential information 387a, 387b may be stored in one or more secure partitions 385a, 385b of the memory module 390. Each secure partition may be associated with a separate credential issuing authority 392a, 392b and may store personal credential information associated with that credential issuing authority 392a, 392b. The secure partitions may, for example be secured in the sense that they are encrypted and access may be controlled using associated secure area access keys.

A credential issuing authority 392a, 392b refers to a system that is authorized to access a secure partition 385a, 385b in order to store personal credential information 387a, 387b associated with a user of the mobile communication device 102 on that secure partition 385a, 385b. Such authorization may be provided to the credential issuing authority 392a, 392b by a mobile network operator (MNO) and/or a mobile wallet provider (MWP) associated with the mobile communication device 102.

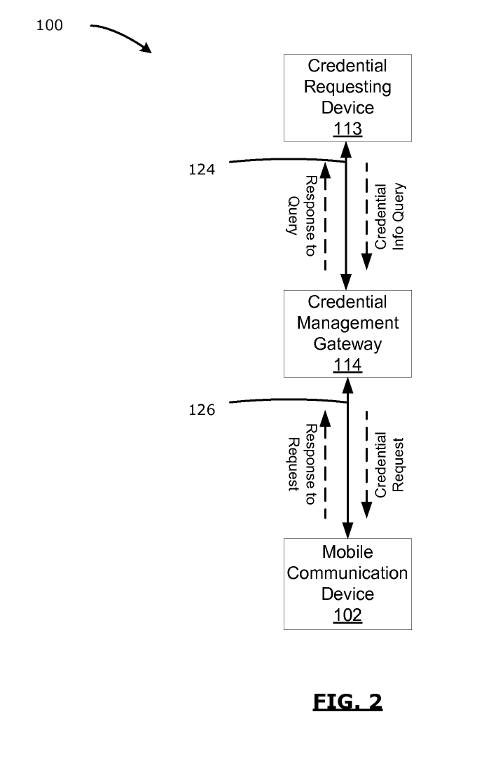

A mobile network operator (MNO) is an organization that provides subscription services, such as voice and data services, to the mobile communication device 102. A MWP is an organization that provides mobile wallet services to the mobile communication device 102. More particularly, the MWP may provide a credential management gateway 114 (FIG. 2). As will be described in greater detail below, the credential management gateway 114 is configured to allow third party systems (which may be referred to as “credential requesting devices” 113 (FIG. 2)) to find out information about personal credentials that are associated with a user of the mobile communication device. The MWP and the MNO may, in some embodiments, be a single operator that provide mobile network operator services and mobile wallet services. It will be appreciated that any reference to the MNO, the MWP and the credential issuing authority, refers to systems that are associated with these organizations and that are configured to perform the functions of those organization described herein.

Accordingly, the MNO and/or the MWP may provide the credential issuing authority 392a, 392b with one or more secure area access keys that allows the credential issuing authority 392a, 392b to access the secure partition 385a, 385b. In doing so, the MNO authorizes the credential issuing authority 392a, 392b to access that secure partition 385a, 385b to store personal credential information 387a, 387b on that secure partition 385a, 385b. Such secure area access keys may be provided over a secure connection between the credential issuing authority 392a, 392b (which is a system having a processor and memory) and a system associated with the MNO and/or the MWP. More particularly, the secure area access keys that are used to access the secure partitions 385a, 385b of the mobile communication device 102 may be provided over an encrypted communication link which may be referred to as a business-to-business connection. This secure link ensures that only an authorized credential issuing authority 392a, 392b is able to access the secure partition 385a, 385b.

The secure area access key that is provided to the credential issuing authority 392a, 392b to allow the credential issuing authority to access the mobile communication device 102 may be a device-specific key. That is, the secure area access key may be provided to the credential issuing authority 392a, 392b together with a unique identifier of the mobile communication device 102 associated with that secure area access key. For example, the secure area access key may be associated with an International Mobile Equipment Identity (IMEI) which identifies the mobile communication device 102 having the secure partition 385a, 385b which may be accessed using that secure area access key.

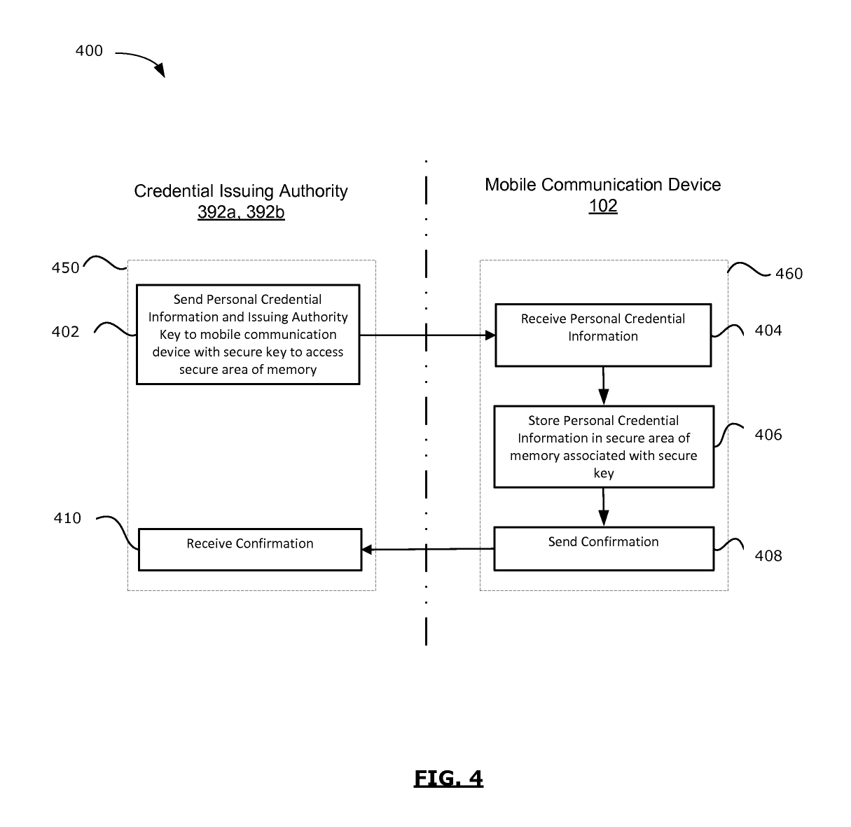

The credential issuing authority 392a, 392b communicates with the mobile communication device 102 (via a communication subsystem 380, 382 associated with the mobile communication device 102) and uses the secure area access key provided by the MNO and/or MWP to access the secure partition 385a, 385b of the mobile communication device 102 to load personal credential information 387a, 387b onto the memory module 390 and, more particularly, onto the secure partition 385a, 385b of the memory module 390. Methods for loading such personal credential information 387a, 387b onto a mobile communication device 102 will be described in greater detail below with reference to FIG. 4.

As will be described in greater detail below with reference to FIG. 4, when the credential issuing authority 392a, 392b stores the personal credential information 387a, 387b on memory associated with the mobile communication device 102 it may also store an issuing authority key 383a, 383b associated with the credential issuing authority 392a, 392b. The issuing authority key 383a, 383b is a key that is associated with the issuing authority that issued the personal credential information 387a, 387b. More particularly, the issuing authority key 383a, 383b is a security key that may be used to verify that the trusted credential issuing authority 392a, 392b provided the personal credential information. That is, the issuing authority key 383a, 383b may be used to verify that the personal credential information was not fraudulently provided by an untrusted system or device.

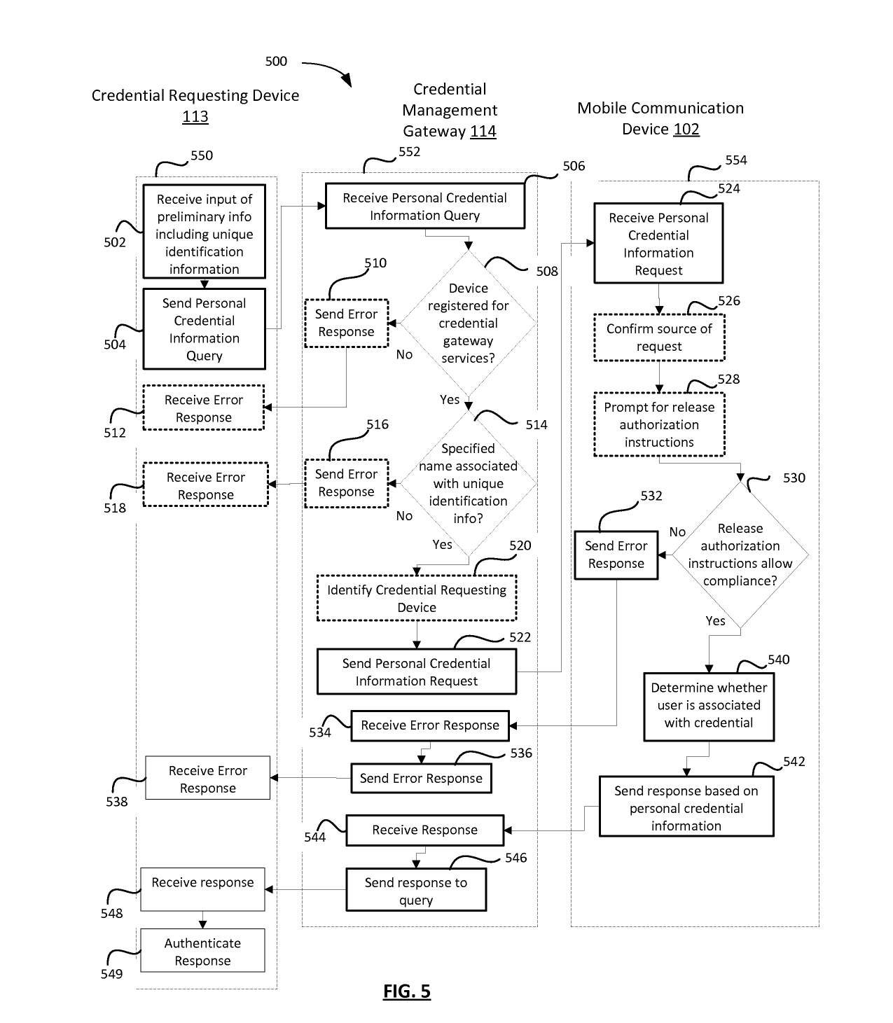

The issuing authority key 383a, 383b may be stored in the secure partition 385a, 385b that stores the personal credential information 387a, 387b stored by the credential issuing authority 392a, 392b that is associated with that key. As will be explained in greater detail below with reference to FIG. 5, when a credential management gateway 114 requests personal credential information from the mobile communication device 102, the mobile communication device 102 may provide the issuing authority key 383a, 383b when responding to the request. This allows the credential management gateway (or a credential requesting device 113 that submitted a personal credential information query to the credential management gateway) to verify that the personal credential information 387a, 387b used to respond to the request was loaded onto the mobile communication device 102 by a trusted credential issuing authority and that it was not fraudulently provided by another system or device.

The credential issuing authority 392a, 392b is a system that is associated with a trusted organization which manages personal credential information. The organization may, for example, be a governmental organization such as, for example, a citizenship bureau (which may load personal credential information onto the mobile communication device 102 which specifies whether a user is a citizen), an immigration bureau (which may load personal credential information onto the mobile communication device 102 which specifies a user's citizenship status), a driver's license issuing authority (which may load personal credential information onto the mobile communication device 102 which specifies whether a user has a valid driver's license), etc.

In some embodiments, the organization may be a non-government private member's group or club. For example, the organization may be a golf club, fitness club or other club that may manage a list of registered members. In such examples, the personal credential information 387a, 387b that is loaded onto the mobile communication device 102 by the credential issuing authority 392a, 392b may indicate whether the user is a member of that organization.

By way of further example, the organization may be an academic organization such as a degree-granting institution. Such an institution may, for example, be a college or university. In such examples, the personal credential information 387a, 387b that is loaded on to the mobile communication device 102 by the credential issuing authority 392a, 392b may specify academic accomplishments of the user. For example, such personal credential information may specify whether the user has been granted a degree or certificate from the institution. The personal credential information may, in some embodiments, particularize the type of degree granted (e.g. whether it is a Bachelor degree, a masters degree a PhD degree and/or any area of specialization associated with the degree). The personal credential information may, in some embodiments, include transcript information specifying a completion status of various courses and/or a grade associated with such courses.

It will be appreciated that other types of organization may operate systems which act as credential issuing authorities 392a, 392b.

In the example illustrated, two credential issuing authorities 392a, 392b are illustrated. These credential issuing authorities 392a, 392b may each be associated with different organizations. For example, a first credential issuing authority 392a may be associated with a government organization that issues identification documents (such as a driver's license bureau) and a second credential issuing authority 392b may be associated with a private (i.e. non-government) organization which maintains a roster of members of that organization (such as a golf club). Each credential issuing authority 392a, 392b may load personal credential information 387a, 387b onto a separate secure partition. The first credential issuing authority 392a may be associated with a first secure partition 385a and the second credential issuing authority 392b may be associated with a second secure partition 385b. That is, the first credential issuing authority 392a may have access to a first secure area access key that allows it to access and load personal credential information 387a onto the first secure partition 385a but not the second secure partition 385b while the second credential issuing authority 392b may have access to a second secure area access key that allows it to access and load personal credential information 387b onto the second secure partition 385b but not the first secure partition 385b. Lines with arrows are used to illustrate the path by which such personal credential information may be loaded on to the memory module 390.

In the example shown, the mobile communication device 102 is configured to communicate with credential issuing authorities 392a, 392b over a plurality of communication subsystems 380, 382. More particularly, a short-range communication subsystem 382 may communicate with a credential issuing authority 392b in close proximity to the mobile communication device 102. The short-range communication subsystem 382 may, for example, be a near-field communication (NFC) subsystem or a Bluetooth™ subsystem. A wireless or wired communication subsystem 380 may allow the mobile communication device 102 to communicate with a more remote credential issuing authority 392a. That is, the credential subsystem 382 may allow the mobile communication device 102 to communicate with the credential issuing authority 392a over longer distances.

In at least some example embodiments, the communication subsystem 380 may allow the mobile communication device 102 to communicate over a Wireless Wide Area Network (WWAN), a Wireless Local Area Network (WLAN), a network of another type (such as the Internet), or a combination of these networks. A WWAN is commonly referred to as a “cellular network”, and may include a number of transceiver base stations. Each of the transceiver base stations provides wireless radio frequency coverage for a corresponding area or cell, in order to facilitate wireless communication for the mobile communication device.

A WWAN may be operated by the MNO. The WWAN may conform to various network types (such as, GSM, GPRS, LTE, TDMA, CDMA, etc.), and may support a number of frequency bands for communications within a particular wireless network type (for example, in the GSM network, the transceiver base station may support four frequency bands: 850/900/1800/1900 MHz). The WWAN via a transceiver base station provides a number of channels within a frequency band to allow the mobile communication device 102 to communicate. That is, the transceiver base station assigns an available channel to the mobile communication device 102 to establish a communication link within the WWAN.

Accordingly, the communication subsystem 380 may, in at least some embodiments, allow the mobile communication device 102 to connect to the credential issuing authority 392b over a network.

While the example of FIG. 1 illustrates a mobile communication device 102 that is configured to communicate with credential issuing authorities 392a, 392b using more than one communication subsystem 380, 382, in other embodiments, a single communication subsystem may be used. For example, in some embodiments, use of an NFC based short range communication subsystem 382 may be required in order to communicate with a credential issuing authority 392a, 392b. The use of such a short-range communication subsystem may provide a further level of security since it may require a user to be physically present with the mobile communication device 102 (i.e. it requires the mobile communication device 102 to be near the credential issuing authority) before the personal credential information 387a, 387b is loaded onto the mobile communication device 102. Such physical presence may allow the user's identity to be verified before the personal credential information is loaded onto the mobile communication device 102.

The processor 340 may operate under stored program control and may execute software modules 360 stored on the memory 350. The software modules 360 may be comprised of, for example, operating system 362 software, and one or more additional modules such as a credential management application 364 to carry out specific functions of the mobile communication device 102.

The operating system 362 is software that manages the mobile communication device 102 components (such as the input interface 320, the display 322, the communication subsystem 380, etc.) and provides a platform for the software modules 360. The operating system 362 also acts as an intermediary between the mobile communication device 102 components and the software modules 360. For example, the operating system 362 may recognize data that is being input from an input device and route the inputted data to be executed by a software module 360. The operating system 362 may be Microsoft Windows OS™, iOS™, Linux™, UNIX™, Android™ or any other operating system 362 having the necessary capabilities for implementing the functions described herein.

The credential management application 364 is configured to manage access to personal credential information 387a, 387b stored on memory associated with the mobile communication device 102. More particularly, as will be described in greater detail below with reference to FIG. 5, the credential management application 364 may be configured to control access to the personal credential information 387a, 387b stored in memory of the mobile communication device 102 (such as in the memory module 390) and may access such personal credential information 387a, 387b to respond to requests received from a credential management gateway 114 when release authorization instructions received from a user authorize such release.

The release authorization instructions are instructions which may be received, for example, via an input interface 320 of the mobile communication device 102. These instructions dictate how the mobile communication device 102 is to handle a request received from a credential management gateway. More particularly, the release authorization instructions indicate whether the mobile communication device 102 is permitted to comply with the request by accessing the personal credential information 387a, 387b.

In some embodiments, preferences 389 may be stored in memory associated with the mobile communication device 102, such as in the memory module 390. Such preferences 389 may specify release authorization instructions which may be used in order to control the handling of personal credential information requests received from a credential management gateway. That is, the preferences 389 may be predefined before such a request is received and retrieved by the credential management application 364 in order to determine handling of the request. In some embodiments, the preferences specify permissions associated with a specific credential requesting device. More particularly, the preferences may indicate whether the mobile communication device 102 is to comply with requests from the credential requesting device. Other types of preferences may be set in other embodiments.

In order to allow the credential management application 364 to access the secure partitions 385a, 385b, the credential management application may have access to the secure area access keys associated with the partitions. Such keys may be securely stored in memory associated with the mobile communication device 102.

In at least some example embodiments, other modules, such as the operating system 362 may perform some or all of the functions of the credential management application 364. In at least some example embodiments, the credential management application 364 may instead include a plurality of software modules rather than a single block as illustrated.

### Example Credential Providing System

Accordingly, the mobile communication device 102 may accept personal credential information from trusted credential issuing authorities and may store such information on a secure partition 385a, 385b of a memory module associated with the mobile communication device 102. Having such personal credential information loaded thereon, the mobile communication device 102 may then respond to requests from a credential management gateway 114 that relate to the personal credential information. More particularly, the credential management gateway 114 acts as a centralized system which links a plurality of credential requesting devices 113 to a plurality of mobile communication devices 102. The credential management gateway 114 acts as a centralized hub through which a credential requesting device 113 may submit a personal credential information request to a mobile communication device.

An overview having been provided, reference is now made to FIG. 2, which illustrates in block diagram form an example credential providing system 100 in which example embodiments of the present disclosure may operate. The credential providing system 100 includes an example credential requesting device 113. The credential requesting device 113 is an electronic device having a processor and an associated memory. The processor is configured to perform a number of functions which will be discussed in greater detail below with reference to FIG. 5. Generally, the credential requesting device 113 is pre-programmed with an address (such as an Internet Protocol address) associated with a credential management gateway 114 which allows the credential requesting device 113 to contact the credential management gateway 114 to submit a credential information query.

The credential requesting device 113 may be associated with any organization that may wish to ascertain whether a person has a specific credential. For example, the credential requesting device 113 may be associated with an organization that may wish to determine whether a particular person has a particular credential. For example, the organization may wish to determine whether the person: has a valid driver's license, is employed, is a citizen of a particular country, is a member of a particular professional organization (e.g. whether they are a licensed doctor, lawyer, engineer, pharmacist, etc.), is a member of a particular club or group (e.g. whether they are a member of a particular fan club, fitness club, golf club, or a club or group of another type), or has a valid visa allowing them to work in a particular country. The organization may wish to determine whether a user has other credentials in other embodiments.

By way of example, the credential requesting device 113 may be associated with a prospective employer of the person, a government organization (such as a health card issuing bureau, a welfare office, a driver's license bureau, etc.), a club or a group, etc.

A person may provide some preliminary information to the credential requesting device 113 which allows the credential requesting device 113 to then ascertain whether the person has a particular credential by interacting with a credential management gateway 114. Such preliminary information may, for example, include a phone number associated with a mobile communication device 102 used by that person. The person may, therefore, be referred to as a “user” of the mobile communication device 102.

Such preliminary information may, in at least some examples, be provided to the credential requesting device 113 through an input interface associated with the credential requesting device 113. This input interface may, for example, be a keyboard and/or a mouse that may be manipulated by an operator of the credential requesting device 113. For example, the person may, in some examples, interact with the operator over the phone or in-person. The person may, for example, attend a location where the input interface is located and, in some cases, where the operator is located and may provide the preliminary information to the credential requesting device 113 (e.g. by inputting the personal information directly into the credential requesting device by using the input interface or by informing the operator of the preliminary information so that the operator may input the information using the input interface).

The preliminary information, in at least some embodiments, includes a phone number or other identification information associated with the mobile communication device 102 used by the person. The preliminary information may also include an identifier of the user, such as a name of the user and, in some embodiments, a birthday associated with the user. Other preliminary information may also be obtained by the credential requesting device 113 from the user instead of or in addition to the information described above.

Some or all of this preliminary information obtained from a user may then used to determine whether the user has a particular personal credential. For example, the preliminary information may be used to then determine whether the user: has a valid driver's license, is employed, is a citizen of a particular country, is a member of a particular professional organization (e.g. whether they are a licensed doctor, lawyer, engineer, pharmacist, etc.), is a member of a particular club or group (e.g. whether they are a member of a particular fan club, fitness club, golf club, or a club or group of another type), or has a valid visa allowing them to work in a particular country.

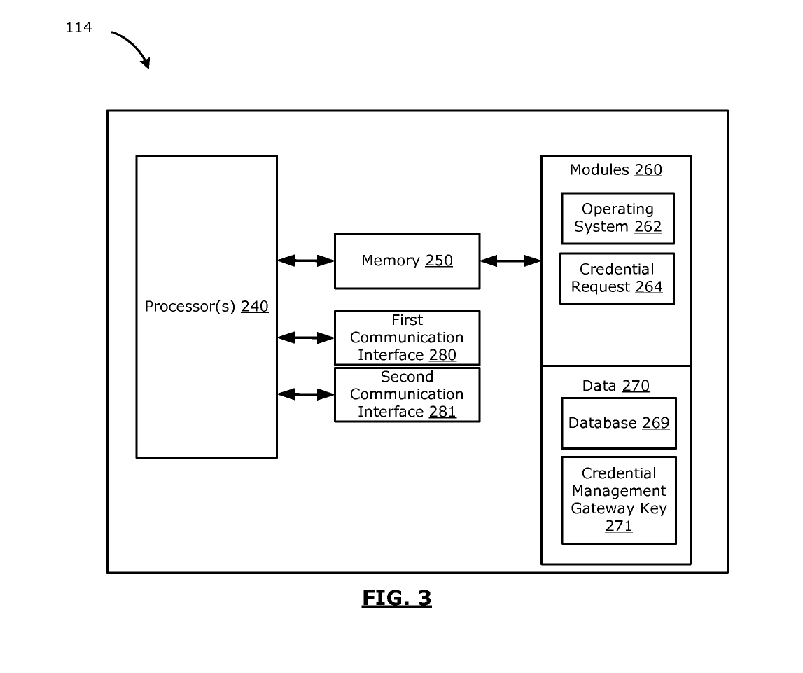

In order to determine whether the user has a particular credential, a credential management gateway 114 is provided in the credential providing system 100. The credential management gateway 114 will be described in greater detail below with reference to FIGS. 3 to 5.

The credential management gateway 114 acts as a centralized location which links mobile communication devices 102 with credential requesting devices 113. More particularly, the credential management gateway 114 is configured to interact with a plurality of mobile communication devices 102 and a plurality of credential requesting devices 113 to allow the credential requesting devices 113 to determine whether a user has a particular credential.

As will be described below, the credential management gateway 114 is configured to receive a personal credential information query from a credential requesting device 113 and, in response, to submit a credential request to a mobile communication device 102 (which may be a device of the type described with reference to FIG. 1). The mobile communication device 102 may, in accordance with user instructions, respond to such requests based on personal credential information stored in memory associated with the mobile communication device 102. Upon receiving this response, the credential management gateway 114 may respond to the credential requesting device's query. Thus, the credential requesting device 113 effectively asks the credential management gateway 114 whether a user associated with particular preliminary information has a particular credential. The credential management gateway 114, upon receiving this request, relays the question to the appropriate mobile communication device 102 (which may be selected based on preliminary information such as a phone number). If the user of the mobile communication device 102 authorizes the device to respond to the question, then the mobile communication device 102 may respond based on secure personal credential information 387a, 387b stored in memory associated with the mobile communication device 102. The credential management gateway 114, upon receiving this response, effectively forwards it onward to the credential requesting device 113 which initially posed the question.

In at least some embodiments, the credential requesting device 113 and the credential management gateway 114 may be connected via a secure business-to-business connection 124. The secure business-to-business connection 124 is an encrypted connection which allows for safe communications. More particularly, the connection employs encryption techniques which allow the credential requesting device 113 to confirm that a response to a personal credential information query is received from the credential management gateway 114 and not from a fraudulent system posing as the credential management gateway 114. Similarly, the secure business-to-business connection 124 allows the credential management gateway 114 to also verify that a personal credential information query is received from an authorized credential requesting device 113 and not from a fraudulent system that is not authorized to submit such queries to the credential management gateway 114. Communications sent from the credential management gateway 114 to the credential requesting device 113 may be encrypted at the credential management gateway 114 and communication sent from the credential requesting device 113 to the credential management gateway 114 may be encrypted at the credential requesting device 113.

The credential management gateway 114 may be connected to the mobile communication device 102 over a wireless connection 126 which may, in at least some embodiments, include a network, such as a Wireless Wide Area Network (WWAN), a Wireless Local Area Network (WLAN), a network of another type (such as the Internet), or a combination of these networks. One or more of these networks may be provided by a mobile network operator (MNO) such as a cellular services provider.

### Example Credential Management Gateway

Referring now to FIG. 3, a block diagram of an example credential management gateway 114 is illustrated.

In at least some embodiments, the functions of the credential management gateway 114 may be implemented, in whole or in part, by way of a processor 240 which is configured to execute software modules 260 stored in memory 250. In the embodiment of FIG. 3, the credential management gateway 114 includes a controller comprising one or more processors 240 which control the overall operation of the credential management gateway 114. The processor 240 interacts with one or more communication interfaces 280, 281 to communicate with other systems, servers and/or devices such as the mobile communication device 102 (FIG. 2) and the credential requesting device 113 (FIG. 2).

In at least some embodiments, the credential management gateway 114 may include multiple communication interfaces, each coupled with the processor 240. A first communication interface 280 may be used for communicating with the credential requesting device 113 (FIG. 2) and a second communication interface 281 may be used for communicating with a mobile communication device 102 (FIGS. 1 and 2). In other embodiments, a single communication interface may be used for communicating with both the mobile communication device 102 and the credential requesting device 113.

The credential management gateway 114 also includes memory 250 which is connected to the processor 240 for receiving and sending data to the processor 240. While the memory 250 is illustrated as a single component, it will typically be comprised of multiple memory components of various types. For example, the memory 250 may include Random Access Memory (RAM), Read Only Memory (ROM), a Hard Disk Drive (HDD), Flash Memory, or other types of memory.

It will be appreciated that each of the various memory types will be best suited for different purposes and applications.

The processor 240 may operate under stored program control and may execute software modules 260 stored on the memory 250. The software modules 260 may be comprised of, for example, operating system software 262, and one or more additional modules such as a credential request module 264. The credential request module 264 may configure the processor 240 to carry out the functions of the credential management gateway 114 described below with reference to FIG. 5.

In at least some example embodiments, other modules, such as the operating system 262 may perform some or all of the functions of the credential request module 264. In at least some example embodiments, the credential request module 264 may instead include a plurality of software modules rather than a single block as illustrated.

The memory 250 may also include data 270. The data, in some embodiments, includes a database 269. As will be described in greater detail below, the database may be used in order to perform credential management gateway functions. For example, in some embodiments, the database 269 may identify users and/or mobile communication devices 102 who are registered to use the credential management gateway 114 services. For example, the credential management gateway 114 may not provide such services for all possible mobile communication devices. Instead, the credential management gateway 114 may provide credential management gateway services only for users and/or mobile communication devices that are registered with the credential management gateway 114. For example, as noted above, the credential management gateway 114 may be associated with a specific mobile network operator (MNO) and/or mobile wallet provider (MWP). In some such embodiments, the database 269 may identify registered users and/or mobile communication devices 102. As will be explained below with reference to 508 of the method 500 of FIG. 5, when a personal credential information query is received from a credential requesting device 113, the credential management gateway 114 may consult the database 269 to determine whether the user and/or mobile communication device 102 associated with the request is registered. If the user and/or the mobile communication device 102 is not registered, then an error response may be sent to the credential requesting device 113.

In some embodiments, the database 269 may associate a user with a mobile communication device 102. For example, a user may be identified in the database by a name and a mobile communication device 102 may be identified by a phone number. The database 269 may establish a link between a user and a device e.g. by linking a name and a number. As will be explained below with reference to 514 of the method 500 of FIG. 5, when a personal credential information query is received from a credential requesting device 113 and the personal credential information query includes preliminary information specifying a name associated with the request and unique identification information (such as a phone number) for a mobile communication device 102 that is also associated with the request, the credential management gateway 114 may consult the database 269 to determine whether the name and the unique identification information (e.g. the phone number) are associated. That is, the credential management gateway 114 determines whether the name and the phone number are linked in the database i.e. whether a user having the specified name is associated with the specified phone number. If not, then an error response may be sent to the credential requesting device 113.

The database 269 may store other information instead of or in addition to the information noted above. Furthermore, in at least some embodiments, the credential management gateway 114 may include multiple databases.

The memory 250 may also store a credential management gateway key 271. The credential management gateway key 271 may be included in the response that is sent from the credential management gateway 114 to the credential requesting device 113 to allow the credential requesting device 113 to verify the source of the response to the personal credential information query. For example, the credential management gateway key 271 may periodically be changed by the credential management gateway 114. A given credential management gateway key 271 may only remain in effect at the credential management gateway 114 for a brief period of time. During this time, after receiving a response to a personal credential information query which includes the credential management gateway key 271, the credential requesting device 113 may send a message to the credential management gateway 114 or an affiliated system to ensure that the key is valid. That is, the credential requesting device 113 may effectively ask the credential management gateway 114 whether the key is one that was recently used by the credential management gateway 114. This check may assist, in at least some embodiments, to reduce the risk that a fraudulent system may pose as a credential management gateway 114 and dupe the credential requesting device 113.

It will be appreciated that the credential management gateway 114 as illustrated in FIG. 3 is an example of components of one possible credential management gateway 114. In at least some example embodiments, a credential management gateway 114 may be used which is of a different configuration and/or which has different functions.

### Loading Personal Credential Information

Referring now to FIG. 4, an example method 400 of loading personal credential information onto a mobile communication device 102 is illustrated in flowchart form. The method 400 may be performed by a system which includes a credential issuing authority 392a, 392b and a mobile communication device 102.

Portions of the method 400 may be implemented by the credential issuing authority 392a, 392b and portions of the method 400 may be implemented by the mobile communication device 102. Since processing of the method 400 is divided among a plurality of devices, the method 400 includes multiple sub-methods. The portions of the method 400 that may be performed by the credential issuing authority 392a, 392b form a method 450 and the portions of the method 400 that may be performed by the mobile communication device 102 form a method 460.

One or more modules on the credential issuing authority 392a, 392b associated with a processor of the credential issuing authority, may perform the method 450 and one or more modules on the mobile communication device 102, such as the credential management application 364, may perform the method 460. For example, the credential management application 364 may contain computer readable instructions causing the processor 240 associated with the mobile communication device 102 to perform the functions of the method 460.

The method 400 of FIG. 4 may be performed after a secure partition 385a, 385b has been configured in memory of a memory module 390 associated with the mobile communication device 102 and the secure area access key that provides access to that secure partition 385a, 385b has been provided to the credential issuing authority 392a, 392b. Thus, the method 400 may begin after the credential issuing authority 392a, 392b has already obtained the secure area access keys that allow it to access the secure partition 385a, 385b.

At 402, the credential issuing authority 392a, 392b sends personal credential information 387a, 387b to the mobile communication device 102. The credential issuing authority 392a, 392b may also send the secure area access key that allows it to access a secure area of memory, which may be referred to as a secure partition 385a, 385b. As noted in the discussion of FIG. 1, the secure partition 385a, 385b may be provided on a removable memory module 390, such as a SIM. The credential issuing authority may also send an issuing authority key to the mobile communication device. As noted previously, the issuing authority key may be used to verify the credential issuing authority.

The personal credential information is received at the mobile communication device from the credential issuing authority 392a, 392b at 404 via a communication subsystem 380, 382 (FIG. 1) of the mobile communication device 102.

At 406, the mobile communication device 102 stores the personal credential information 387a, 387b in the secure area of memory that is associated with the secure area access key that was provided by the credential issuing authority. That is, the personal credential information 387a, 387b is stored in the secure partition 385a, 385b associated with that secure area access key. The secure partition 385a, 385b may be an area of memory that is specifically designated to a single credential issuing authority 392a, 392b. The issuing authority key may also be stored; e.g. in the secure partition.

In some embodiments, at 408, the mobile communication device 102 sends a confirmation to the credential issuing authority 392a, 392b to confirm that the personal credential information 387a, 387b has been loaded onto the mobile communication device 102. This confirmation may be received at the credential issuing authority 392a, 392b at 410.

Providing Information about Credentials to Credential Requesting Device

After personal credential information 387a, 387b has been stored on the mobile communication device 102, this personal credential information 387a, 387b may be used to inform a credential requesting device 113 whether a user associated with the mobile communication device 102 has a particular credential.

Referring now to FIG. 5, an example method 500 of providing information about credentials to a credential requesting device 113 is illustrated in flowchart form. The method 500 may be performed by a system which includes a credential requesting device 113, a credential management gateway 114 and a mobile communication device 102.

Portions of the method 500 may be implemented by the credential requesting device 113, portions of the method 500 may be implemented by the credential management gateway 114 and portions of the method 500 may be implemented by the mobile communication device 102. Since processing of the method 500 is divided among a plurality of devices, the method 500 includes multiple sub-methods. The portions of the method 500 that may be performed by the credential requesting device 113 form a method 550, the portions of the method 500 that may be performed by the credential management gateway 114 form a method 552, and the portions of the method 500 that may be performed by the mobile communication device 102 form a method 554.

One or more modules on the credential requesting device 113 associated with a processor of the credential requesting device, may cause the processor to perform the method 550. Similarly, one or more modules associated with a processor on the credential management gateway 114 (such as a credential request module 264) may cause that processor 240 to perform the method 552. For example, the credential request module 264 may contain computer readable instructions causing the processor 240 associated with the credential management gateway 114 to perform the functions of the method 552. Similarly, one or more modules associated with a processor 340 on the mobile communication device 102 (such as a credential management application 364) may cause that processor to perform the method 554. For example, the credential management application 364 may contain computer readable instructions causing the processor 240 associated with the mobile communication device 102 to perform the functions of the method 554.

At 502, the credential requesting device 113 receives an input of preliminary information. Such preliminary information may, for example, include unique identification information associated with a user (i.e. a person) and/or a mobile communication device 102. For example, the preliminary information may include a phone number associated with a mobile communication device 102 and/or may include a name associated with a user of that mobile communication device. Accordingly, the preliminary information, in at least some embodiments, includes a phone number or other identification information associated with the mobile communication device 102 used by the person. The preliminary information may also include an identifier associated with the user, such as a name of the user and, in some embodiments, a birthday associated with the user. Other preliminary information may also be obtained by the credential requesting device 113 from the user instead of or in addition to the information described above.

The preliminary information may, in at least some examples, be input to the credential requesting device 113 through an input interface associated with the credential requesting device 113. This input interface may, for example, be a keyboard and/or a mouse that may be manipulated by an operator of the credential requesting device 113.

Then, at 504, the credential requesting device sends a personal credential information query to the credential management gateway based on the preliminary information. The query indicates unique identification information which was received at the credential requesting device as the preliminary information. The unique identification information, in at least some embodiments, is a telephone number (note that the term “telephone number” has, in some instances of this document been abbreviated as “phone number”) associated with a mobile communication device.

The query may, in at least some embodiments, identify a user. The identification of a user may be done instead of or in addition to the identification of a phone number. That is, in some embodiments, the query may specify a phone number but not a name, in other embodiments, the query may specify a name but not a phone number, and in yet other embodiments, the query may specify a name and a phone number.

The query may include other preliminary information instead of or in addition to the information noted above (i.e. instead of or in addition to the name and/or phone number). For example, in some embodiments, a birthdate may be included.

The query also includes type information indicating particulars of the query. More particularly, the type information may specify a credential associated with the request. For example, the type information specifies a credential which the credential requesting device 113 is interested in. That is, the query effectively asks whether the person having the included preliminary information (e.g. the specified name and/or number) has the specified credential.

The credential specified by the type information may, for example, be a driver's license, a passport, an immigration or citizenship status, an employment status, a professional designation or a membership status for a group or club, etc. For example, the personal credential information query may effectively ask whether a person who has a specified name and/or who is associated with a mobile communication device 102 having a specified phone number: has a valid driver's license, is employed, is a citizen of a particular country, is a member of a particular professional organization (e.g. whether they are a licensed doctor, lawyer, engineer, pharmacist, etc.), is a member of a particular club or group (e.g. whether they are a member of a particular fan club, fitness club, golf club, or a club or group of another type), or has a valid visa allowing them to work in a particular country. The queries may be of other types in other embodiments.

The query may also, in at least some embodiments, include credential requesting device identifying information which identifies the credential requesting device. This may, for example, be a unique identification name or number associated with the credential requesting device 113. For example, the unique identification number may be an Internet Protocol (IP) address associated with the credential requesting device 113.

The query may be sent over a secure business-to-business connection 124 which may be of the type described above with reference to FIG. 2.

The personal credential information sent from the credential requesting device 113 is received at the credential management gateway 114 at 506. A number of steps may be performed by the credential management gateway 114 in response to receiving the personal credential information query.

In some embodiments the credential management gateway may validate the query to determine whether the query is something that the credential management gateway 114 will act on. More particularly, in some embodiments, the credential management gateway 114 may, at 508, determine whether the mobile communication device 102 associated with the request is a mobile communication device for which the credential management gateway is configured to provide credential management services. This determination may be made, for example, by consulting a database 269 (FIG. 3) associated with the credential management gateway. The database 269 may identify mobile communication devices 102 and/or users that are registered for credential management services (i.e. that are registered to use the credential management gateway 114) and the credential management gateway 114 may compare information in the query to information in the database to determine whether the user and/or mobile communication device 102 is registered. For example, the credential management gateway 114 may use a phone number included in the query to determine whether the mobile communication device 102 associated with that phone number is registered.

In at least some embodiments, if the credential management gateway 114 determines that the mobile communication device 102 is not registered for credential gateway services, then the credential management gateway 114 may send (at 510) an error response to the credential requesting device 113, which may be received at 512. The error response may inform the credential requesting device 113 that the mobile communication device 102 and/or the user is not registered for credential management services and the credential requesting device 113 may display an error message on an associated display to inform an operator that the credential management gateway 114 was unable to determine whether the user has the specified credential.

If, however, the credential management gateway 114 determines (at 508) that the mobile communication device 102 is registered for credential gateway services, then the credential management gateway 114 may proceed to perform other steps of the method 552. For example, optionally, at 514, the credential management gateway 114 may determine, from a database 269 (FIG. 3) associated with the credential management gateway, whether the specified name received in the query is associated with the specified unique identification information (e.g. the phone number) received in the query. That is, the credential management gateway 114 may determine whether a user having the specified name is associated with the specified unique identification information. If the user and the phone number are not associated with one another, then an error response may be sent to (at 516) the credential requesting device 113 where it is received at 518.

The error response may inform the credential requesting device 113 that the mobile communication device 102 associated with the specified phone number is not associated with the user having the specified name. The credential requesting device 113 may display an error message on an associated display to inform an operator of this error.

If the credential management gateway 114 determines (at 514) that the name and phone number are associated, then the credential management gateway 114 may proceed to perform other steps of the method 552.

It will be appreciated that the determination described at 514 could, instead, occur on the mobile communication device 102. That is, the mobile communication device 102 having the specified number may determine whether it is associated with a specified user and may relay this information to the credential management gateway 114 which may then forward it to the credential requesting device 113.

In some embodiments, at 520, the credential management gateway 114 may identify the credential requesting device 113 which submitted the personal credential information query. The credential management gateway 114 may be configured to receive queries from a plurality of different credential requesting devices 113 which may be associated with different organizations. In at least some embodiments, at 520, the credential management gateway 114 may determine the identity of the credential requesting device 113 that submitted the personal credential information query. As noted above, in at least some embodiments, the query may include credential requesting device identifying information. Thus, in at least some embodiments, the credential management gateway may be provided with information that identifies the credential requesting device 113. However, in other embodiments, other processing may be required in order to identify the credential requesting device (i.e. in order to determine credential requesting device identifying information). For example, in some embodiments, the credential management gateway 114 uses an address associated with the credential requesting device 113 (such as an IP address) to consult a database of credential requesting devices 113 that are registered for use in the system. The database 269 (FIG. 3) may map an address associated with the credential requesting device 113 to a colloquial identifier of a credential requesting device 113. For example, an IP address of 432.234.1.23 may be associated with a colloquial identifier of “Health Card Bureau,” which indicates that queries submitted from that IP address are associated with a Health Card Bureau. The colloquial identifier may, in at least some embodiments, be used as credential requesting device identifying information.

At 522, the credential management gateway 114 sends, to a credential management application 364 (FIG. 1) of the mobile communication device 102 that is associated with the unique identification information in the query (e.g. the phone number), a personal credential information request. That is, the preliminary information included in the query that was received at 506 is used to identify a mobile communication device 102 associated with the query and the personal credential information request is sent to that device. For example, where the query includes a phone number, the personal credential information request is sent to that phone number.

Thus, in response to receiving the personal credential information query, the credential management gateway 114 sends a personal credential information request to the appropriate mobile communication device 102. The credential management gateway 114 effectively relays the query to the appropriate mobile communication device 102. Thus, the personal credential information request may include much the same information as the personal credential information query. For example, the personal credential information request may include preliminary information which may identify the user and/or the mobile communication device such as, for example, a name. The personal credential information request may also include type information indicating particulars of the request. As noted above in the discussion regarding the query, the type information may specify a credential. Thus, the credential management gateway 114 relays the question of whether the user has a specified credential to the mobile communication device 102 which (as will be explained with reference to 540) determines whether the specified user has the specified credential.

The personal credential information request may include credential requesting device identifying information which identifies the credential requesting device 113. This information may be the credential requesting device identifying information that was included in the query and received at 506 and/or may be the credential requesting device identifying information that was determined at 520. For example, in at least some embodiments, the colloquial identifier of the credential requesting device 113 that was determined at 520 may be included in the query.

The personal credential information request may be sent in a manner that allows the credential management application 364 to authenticate source (i.e. to verify that it originated from the credential management gateway 114 and not another system). For example, the personal credential information request may be encrypted in some embodiments.

In at least some embodiments, the personal credential information request is sent as a silent short messaging service (SMS) message.

The personal credential information request may be received at the mobile communication device 102 at 524. That is, the mobile communication device 102 receives the personal credential information request from the credential management gateway 114. The personal credential information request may, for example, be received at the credential management application 364. That is, the credential management application 364 may handle the request. As will be described in greater detail below, the credential management application 364 may be configured to respond to the personal credential information request based on personal credential information stored in a secure area of a memory module associated with the mobile communication device and based on release authorization instructions.

In some embodiments, at 526, the mobile communication device 102 may confirm the source of the personal credential information request. That is, the mobile communication device 102 may confirm that the personal credential information request was received from the credential management gateway 114 and not another system that may, for example, be posing as the credential management gateway 114. This authentication procedure may, for example, rely on a shared secret, such as a key, that is shared between the credential management gateway 114 and the mobile communication device 102.

In at least some embodiments, at 528, the mobile communication device 102 may display a prompt on a display associated with the mobile communication device 102 for input of release authorization instructions. The prompt may, in at least some embodiments, identify the credential requesting device 113 based on the credential requesting device identifying information included in the request. For example, the colloquial identifier of the credential requesting device 113 may be displayed on the display to indicate, to a user, the identity of the credential requesting device 113.

Accordingly, the prompt may request input of release authorization instructions. Release authorization instructions may be received, in such embodiments, via an input interface 320 (FIG. 1) associated with the mobile communication device 102.

At 530, the mobile communication device 102 determines whether release authorization instructions allow for compliance with the personal credential information request. These release authorization instructions may be the instructions received in response to the prompt.

Alternatively, in some embodiments, preferences 389 may have been previously stored in memory associated with the mobile communication device 102. These preferences may include release authorization instructions. In such embodiments, the preferences may be consulted to determine whether the release authorization instructions authorize the mobile communication device 102 to comply with the request. In some embodiments, where preferences are used, the prompt may not be displayed at 528.

The preferences may have been received via an input interface 320 of the mobile communication device 102 before the method 500 was initiated.

In some embodiments, the preferences may specify permissions for a specific credential requesting device. In some such embodiments, when determining whether the preferences authorize the mobile communication device to comply with the personal credential information request, the credential requesting device identifying information may be considered. That is, the mobile communication device 102 may determine whether it is authorized to comply with requests associated with the credential requesting device 113 that sent the query which caused the personal credential information request to be sent.

If the release authorization instructions specify that the request is not to be complied with, then at 532 an error response is sent to the credential management gateway 114. This error response may indicate that the request is not going to be complied with. It is received at 534 at the credential management gateway 114 and sent from the credential management gateway 114 to the credential requesting device 113 at 536. The error response is received at the credential requesting device at 538 and an error message may be displayed on a display associated with the credential requesting device 113.

If, however, the release authorization instructions authorize the mobile communication device 102 to comply with the personal credential information request, then the mobile communication device 102 may comply with the request. More particularly, at 540 the mobile communication device 102 may determine, by consulting personal credential information stored in a secure area of memory (such as a secure partition 385a, 385b (FIG. 1)), whether the identified user is associated with the indicated credential. In some embodiments, the mobile communication device 102 may determine whether a user having a specified name is associated with the mobile communication device 102; and 2) whether that user has the indicated credential (i.e. the credential that was specified in the type information that was included in the request for personal credential information).

The mobile communication device 102, at 542, sends a response to the personal credential information request. This response is prepared based on the personal credential information. More particularly, the response indicates whether the identified user has the indicated credential. If it is determined that the user is not associated with the indicated credential, then the response sent to the credential requesting device indicates that the user is not associated with the indicated credential. If, however, it is determined that the user is associated with the indicated credential, then the response sent to the credential requesting device acknowledges that the user has the indicated credential. This acknowledgment may not provide particulars of the credential. That is, to maintain security over the personal credential information, the mobile communication device 102 may effectively inform the credential management gateway whether the user has the credential without divulging specifics of the credential. By way of example, if the request asks whether the user has a driver's license, a confirmation message may be sent to indicate that the user does, in fact, have a driver's license without providing particulars of the driver's license such as the driver's license number.

In some embodiments, the mobile communication device 102 may include a memory module that has a plurality of secure areas associated with a plurality of credential issuing authorities. In at least some such embodiments, in complying with the request, the mobile communication device 102 may identify the secure area associated with the personal credential information request based on the type information in the personal credential information request. For example, the mobile communication device 102 may identify the secure area that includes personal credential information indicating whether a user has the specified credential.

In at least some embodiments, the secure area of memory that includes the personal credential information associated with the request may also include a key associated with an issuing authority that issued the personal credential information. This key may be referred to as an issuing authority key 383a, 383b. In at least some embodiments, the issuing authority key from the secure area of memory that includes the personal credential information associated with the request may be included in the response sent at 542.

The response to the personal credential information request is received at the credential management gateway 114 at 544.

Then, at 546, the credential management gateway sends a response to the personal credential information query to the credential requesting device based on the response received from the mobile communication device. The response sent to the credential requesting device indicates whether a user associated with the mobile communication device 102 included in the query is associated with a credential specified by the type information included in the query.

The response sent at 546 may indicate whether a user that was identified in the query (e.g. by name) has the indicated credential. As noted above, if it is determined that the user is associated with the indicated credential, the response sent to the credential requesting device may acknowledge that the user has the indicated credential without providing particulars of that credential.

Similarly, if it is determined that the user is not associated with the indicated credential, the response sent to the credential requesting device may indicate that the user is not associated with the indicated credential.

The response sent at 546 may include the issuing authority key and may, in at least some embodiments, include a credential gateway management key 271 (FIG. 3). The credential gateway management key may be stored in memory associated with the credential management gateway and retrieved, at 546 and included in the response. This key verifies the source of the response to the personal credential information query. That is, this key may be used to allow the credential requesting device 113 to verify that the response was provided by the credential management gateway 114 and not by another system fraudulently posing as the credential management gateway 114.

The response is received at 548 at the credential requesting device 113. In at least some embodiments, the response is then may be authenticated at 549 using the credential management gateway key 271 and/or the issuing authority key 383a, 383b.

The method 500 of FIG. 5 may, in at least some embodiments, be modified to include additional steps or fewer steps. By way of example, in at least some embodiments, the credential management gateway 114 may initiate a timer when sending the personal credential information request (i.e. at 522). If a response from the mobile communication device 102 is not received within a predetermined period of time, then a timeout may be detected. This may, for example, occur when a user has their phone in a powered-off mode or sleep mode. Then, the credential management gateway 114 may send an error response to the credential requesting device which may then display an error message on an associated display. This error message may inform an operator that the credential management gateway way unable to reach the mobile communication device 102, allowing the operator to inform the user to turn the device on.

While the present disclosure is primarily described in terms of methods, a person of ordinary skill in the art will understand that the present disclosure is also directed to various apparatus, such as a server and/or an electronic device, including components for performing at least some of the aspects and features of the described methods, be it by way of hardware components, software or any combination of the two, or in any other manner. Moreover, an article of manufacture for use with the apparatus, such as a pre-recorded storage device or other similar computer readable medium including program instructions recorded thereon, or a computer data signal carrying computer readable program instructions may direct an apparatus to facilitate the practice of the described methods. It is understood that such apparatus, and articles of manufacture also come within the scope of the present disclosure.

While the methods have been described as occurring in a particular order, it will be appreciated by persons skilled in the art that some of the steps may be performed in a different order provided that the result of the changed order of any given step will not prevent or impair the occurrence of subsequent steps. Furthermore, some of the steps described above may be combined in other embodiments, and some of the steps described above may be separated into a number of sub-steps in other embodiments.

The various embodiments presented above are merely examples. Variations of the embodiments described herein will be apparent to persons of ordinary skill in the art, such variations being within the intended scope of the present disclosure. In particular, features from one or more of the above-described embodiments may be selected to create alternative embodiments comprised of a sub-combination of features which may not be explicitly described above. In addition, features from one or more of the above-described embodiments may be selected and combined to create alternative embodiments comprised of a combination of features which may not be explicitly described above. Features suitable for such combinations and sub-combinations would be readily apparent to persons skilled in the art upon review of the present disclosure as a whole. The subject matter described herein intends to cover and embrace all suitable changes in technology.

What is claimed is:

1. A method provided by a credential management gateway, the credential management gateway being coupled with a wireless network servicing a plurality of mobile communication devices, the method comprising:
receiving, from a credential requesting device, a personal credential information query, the query indicating unique identification information and type information indicating particulars of the query; and
in response to receiving the personal credential information query:
sending, to a credential management application of the mobile communication device that is associated with the unique identification information, a personal credential information request, the credential management application being configured to respond to the personal credential information request based on personal credential information stored in a secure area of a memory module associated with the mobile communication device and based on release authorization instructions;
receiving, from the mobile communication device, a response to the request; and
sending a response to the personal credential information query to the credential requesting device based on the response received from the mobile communication device, the response sent to the credential requesting device indicating whether a user associated with the mobile communication device is associated with a credential specified by the type information.

2. The method of claim 1, wherein the query identifies a user, and wherein the response to the personal credential information query indicates whether the identified user has the indicated credential.

3. The method of claim 2, wherein the credential management application is configured to determine, based on the personal credential information, whether the identified user is associated with the indicated credential.

4. The method of claim 3, wherein if it is determined that the user is associated with the indicated credential, the response sent to the credential requesting device acknowledges that the user has the indicated credential without providing particulars of that credential.

5. The method of claim 4, wherein, if it is determined that the user is not associated with the indicated credential, the response sent to the credential requesting device indicates that the user is not associated with the indicated credential.

6. The method of claim 2, wherein the user is identified by a name and wherein the credential management gateway is configured to, prior to sending the personal credential information request, determine, from a database associated with the credential management gateway, that a user having the name is associated with the unique identification information.

7. The method of claim 6 wherein the unique identification information is a telephone number associated with the mobile communication device.

8. The method of claim 1, wherein the credential is one of:
a driver's license;
a passport;
an immigration or citizenship status;
an employment status;
a professional designation; or
a membership status for a group.

9. The method of claim 1, wherein the personal credential information request is sent as a silent short messaging service message.

10. The method of claim 1, wherein the personal credential information query is received over a secure business-to-business connection.

11. The method of claim 1, wherein the credential management gateway is configured to include, in the response to the personal credential information query, a key which verifies the source of the response to the personal credential information query.

12. The method of claim 1, wherein the response to the request received from the mobile communication device includes a key associated with an issuing authority that issued the personal credential information.

13. The method of claim 1, wherein the personal credential information request includes credential requesting device identifying information which identifies the credential requesting device and wherein the credential management application is configured to display a prompt for input of release authorization instructions, the prompt identifying the credential requesting device.

14. The method of claim 13, further comprising, prior to sending the personal credential information request, identifying the credential requesting device from which the query was received.

15. The method of claim 1, further comprising, prior to sending the personal credential information request:
determining, based on a database, that the mobile communication device is a mobile communication device for which the credential management gateway is configured to provide credential management services.

16. A credential management gateway comprising:
a first communication interface for communicating with a credential requesting device;
a second communication interface for communicating with a mobile communication device; and
a processor coupled with the first communication interface and the second communication interface, the processor being configured to:
receive, from a credential requesting device, a personal credential information query, the query indicating unique identification information and type information indicating particulars of the query; and
in response to receiving the personal credential information query:
send, to a credential management application of the mobile communication device that is associated with the unique identification information, a personal credential information request, the credential management application being configured to respond to the personal credential information request based on personal credential information stored in a secure area of a memory module associated with the mobile communication device and based on release authorization instructions;
receive, from the mobile communication device, a response to the request; and
send a response to the personal credential information query to the credential requesting device based on the response received from the mobile communication device, the response sent to the credential requesting device indicating whether a user associated with the mobile communication device is associated with a credential specified by the type information.

17. A method provided by a mobile communication device, the method comprising:
receiving personal credential information from a credential issuing authority via a communication subsystem of the mobile communication device;
storing the personal credential information on a secure area of the memory module;
receiving a personal credential information request from a credential management gateway, the credential management gateway being configured to receive a personal information query from a credential requesting device and, in response to receiving the query, to send the personal credential information request, the request specifying type information indicating a credential associated with the request; and
when release authorization instructions received via an input interface of the mobile communication device authorize the mobile communication device to comply with the personal credential information request, sending a response to the request based on the personal credential information.

18. The method of claim 17, wherein the query identifies a user and includes type information indicating a credential associated with the query and wherein the response to the personal credential information query indicates whether the identified user has the indicated credential.

19. The method of claim 18, further comprising:
determining, based on the personal credential information, whether the identified user is associated with the indicated credential.

20. The method of claim 19, wherein if it is determined that the user is associated with the indicated credential, the response sent to the credential requesting device acknowledges that the user has the indicated credential without providing particulars of that credential.

21. The method of claim 20, wherein, if it is determined that the user is not associated with the indicated credential, the response sent to the credential requesting device indicates that the user is not associated with the indicated credential.

22. The method of claim 17, wherein the credential is one of:
a driver's license;
a passport;
an immigration or citizenship status;
an employment status;
a professional designation; or
a membership status for a group.

23. The method of claim 17, wherein the personal credential information request includes credential requesting device identifying information which identifies the credential requesting device, the method further comprising:
displaying a prompt on a display associated with the mobile communication device, the prompt requesting input of release authorization instructions and prompt identifying the credential requesting device based on the credential requesting device identifying information.

24. The method of claim 17, wherein the release authorization instructions comprise preferences previously stored in memory, the method further comprising:
determining whether the preferences authorize the mobile communication device to comply with the personal credential information request.

25. The method of claim 24, wherein the personal credential information request includes credential requesting device identifying information which identifies the credential requesting device, and wherein the preferences specify permissions for a specific credential requesting device, and wherein said determining is performed based on the credential requesting device identifying information.

26. The method of claim 17, further comprising:
confirming that the personal credential information request was received from the credential management gateway and not another system.

27. The method of claim 17, wherein the memory module has a plurality of secure areas associated with a plurality of credential issuing authorities, and wherein the method further comprises identifying the secure area associated with the personal credential information request based on the type information.

28. The method of claim 17, wherein the secure area of memory includes a key associated with an issuing authority that issued the personal credential information and wherein the key is included in the response.
